(19) United States
(12) Patent Application Publication
(10) Pub. No.: US 2023/0332491 A1
(43) Pub. Date: Oct. 19, 2023

(54) Methods of Continuously Capturing Carbon Dioxide from Exhaust Gas Produced from Equipment Operating at Wellsite

(71) Applicant: Halliburton Energy Services, Inc., Houston, TX (US)

(72) Inventors: Philip D. Nguyen, Houston, TX (US); Tatyana Vladimirov Khamatnurova, Houston, TX (US); Ronald Glen Dusterhoft, Houston, TX (US)

(21) Appl. No.: 17/721,045

(22) Filed: Apr. 14, 2022

(51) Int. Cl. E21B 43/16; B01D 53/90; B01D 53/62

(52) U.S. Cl. CPC E21B 43/164; B01D 53/90; B01D 53/62; B01D 2257/504; B01D 2251/606

(57) ABSTRACT

A method including collecting exhaust gas comprising carbon dioxide (CO₂) at a wellsite to provide a collected exhaust gas and contacting the collected exhaust gas with water in the presence of a carbonic anhydrase catalyst to hydrate the CO₂ and form a bicarbonate solution. A system for carrying out the method is also provided.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to systems and methods of continuously capturing carbon dioxide (CO₂) from exhaust gas produced from equipment at a wellsite. More specifically, this disclosure relates to collecting exhaust gas comprising CO₂ and separating CO₂ from the collected exhaust gas via carbonic anhydrase. Still more specifically, this disclosure relates to collecting, from equipment at a wellsite, exhaust gas comprising CO₂, separating at least a portion of the CO₂ from the collected exhaust gas via carbonic anhydrase, thus providing a bicarbonate solution, and sequestering CO₂ by forming a product from the bicarbonate solution, separating CO₂ from the bicarbonate solution and introducing it downhole, and/or introducing the bicarbonate solution downhole.

### BACKGROUND

Natural resources (e.g., oil or gas) residing in a subterranean formation can be recovered by driving resources from the formation into a wellbore using, for example, a pressure gradient that exists between the formation and the wellbore, the force of gravity, displacement of the resources from the formation using a pump or the force of another fluid injected into the well or an adjacent well. A number of wellbore servicing fluids can be utilized during the formation and production from such wellbores. For example, in embodiments, the production of fluid in the formation can be increased by hydraulically fracturing the formation. That is, a treatment fluid (e.g., a fracturing fluid) can be pumped down the wellbore to the formation at a rate and a pressure sufficient to form fractures that extend into the formation, providing additional pathways through which the oil or gas can flow to the well. Subsequently, oil or gas residing in the subterranean formation can be recovered or “produced” from the well by driving the fluid into the well. During production of the oil or gas, substantial quantities of produced water, which can contain high levels of total dissolved solids (TDS), and produced gas can also be produced from the well, and a variety of exhaust gases and flare gases conventionally sent to flare can be formed. For example, oil and gas wells produce oil, gas, and/or byproducts from subterranean formation hydrocarbon reservoirs. A variety of subterranean formation operations are utilized to obtain such hydrocarbons, such as drilling operations, completion operations, stimulation operations, production operations, enhanced recovery operations, and the like. Such subterranean formation operations typically use a large number of vehicles, heavy equipment, and other apparatus (collectively referred to as “machinery” herein) in order to achieve certain job requirements, such as treatment fluid pump rates. Such equipment may include, for example, pump trucks, sand trucks, cranes, conveyance equipment, mixing machinery, and the like. Many of these operations and machinery utilize combustion engines that produce exhaust gases (e.g., including carbon dioxide/greenhouse gas emissions) that are emitted into the atmosphere.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic flow diagram of a method, according to one or more embodiments of this disclosure;

FIG. 2 is a schematic flow diagram of separating CO₂ from bicarbonate solution, according to one or more embodiments of this disclosure;

FIG. 3A is a schematic of a system, according to one or more embodiments of the present disclosure;

FIG. 3B is a schematic of a system, according to one or more embodiments of the present disclosure;

FIG. 4A is a schematic of a system, according to one or more embodiments of this disclosure;

FIG. 4B is a schematic of a system, according to one or more embodiments of this disclosure; and

FIG. 5 is a schematic of a plurality of machinery that may be located and operated at a wellsite for performing a subterranean formation operation and may produce exhaust gas comprising CO₂, according to one or more embodiments of the present disclosure.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

Conventional methods utilized for capturing carbon dioxide (CO₂) from the flue gas and other exhaust gas require large amount of energy to release the CO₂ and regenerate absorbents, which renders them uneconomical. Conventional methods also involve slow processes. CO₂ emission is part of the exhaust gas released from operating equipment (e.g., fracturing equipment at a wellsite). For example, a volume of 300 million cubic feet per day of exhaust gas can be produced from a typical hydraulic fracturing operation. The use of batch mixing provides only limited capability in capturing CO₂ from the vast volume of exhaust gas. Herein disclosed are systems and methods of capturing CO₂ from exhaust gas (e.g., from exhaust gas produced during a hydraulic fracturing operation), that provide for continuous, rapid capture of the CO₂ from large amounts of exhaust gas, and do not require high energy to release the CO₂ or slow absorbent regeneration processes.

Carbonic anhydrases are zinc containing metalloenzymes which catalyze the reversible hydration of carbon dioxide (CO₂). Carbonic anhydrases are important enzymes that catalyze the interconversion between carbon dioxide and water and the dissociated ions of carbonic acid (i.e., bicarbonate and hydrogen ions) as shown by the reaction 1:

CO₂+H₂O↔HCO₃⁻+H⁺ [1]

In mammals, the main role of carbonic anhydrase is to catalyze the conversion of carbon dioxide to carbonic acid and back again. It also helps with CO₂ transport in the blood which in turn helps respiration. The catalyzation of carbonic anhydrase in body tissues is shown by the reaction 2:

CO₂+H₂O→H₂CO₃→H⁺+HCO₃⁻ [2]

The catalyzation of carbonic anhydrase in the lungs which converts bicarbonate to carbon dioxide for exhalation is shown by reaction 3:

H⁺+HCO₃^{-→H}₂CO₃→CO₂+H₂O [3]

Carbonic anhydrase is one of the fastest enzymes known. The active site of carbonic anhydrases can turnover CO₂ and water to bicarbonate and a proton up to millions of times per second. The mechanism of the fast conversion kinetics of CO₂ and water to bicarbonate and back again provided by carbonic anhydrases is utilized herein for capturing CO₂ from an exhaust gas, such as exhaust gas produced at a wellsite. The result is a viable continuous process using small processing equipment at a wellsite, while reducing capital and operating costs.

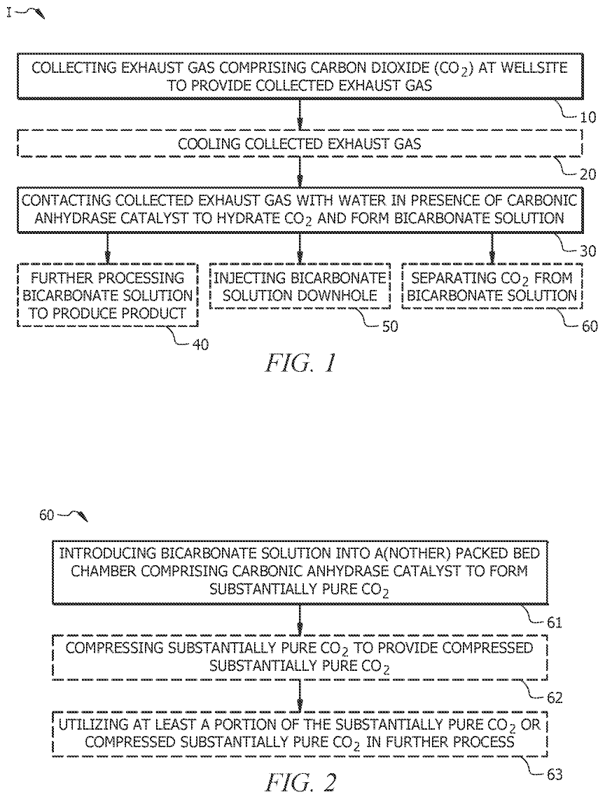

A method of this disclosure will now be described with reference to FIG. 1, which is a schematic flow diagram of a method I according to one or more embodiments of this disclosure. As seen in FIG. 1, method I includes collecting exhaust gas comprising carbon dioxide (CO₂) at a wellsite to provide a collected exhaust gas at 10, and contacting the collected exhaust gas with water in the presence of a carbonic anhydrase catalyst to hydrate CO₂ and form a bicarbonate solution at 30. A method I of this disclosure can further comprise: at 20, cooling the collected exhaust gas; at 40, further processing at least a portion of the bicarbonate solution to produce a product; at 50, injecting at least a portion of the bicarbonate solution downhole; and/or, at 60, separating (e.g., substantially pure) CO₂ from at least a portion of the bicarbonate solution. Although depicted in a certain order in FIG. 1, in embodiments, one or more of steps 10 to 60 (e.g., step 40, 50, and/or 60) can be absent, and/or the one or more of steps 10 to 60 can be performed more than once and/or in a different order than described herein or depicted in the embodiment of FIG. 1.

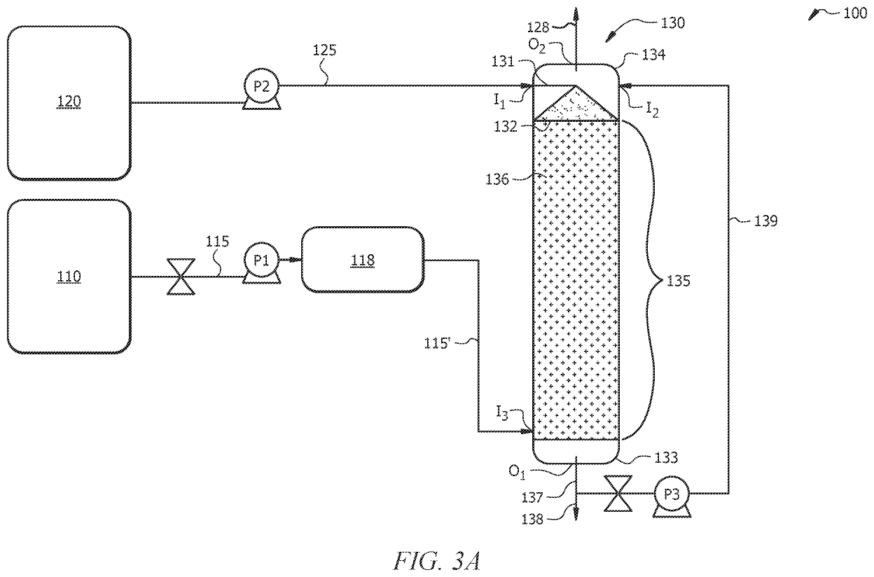

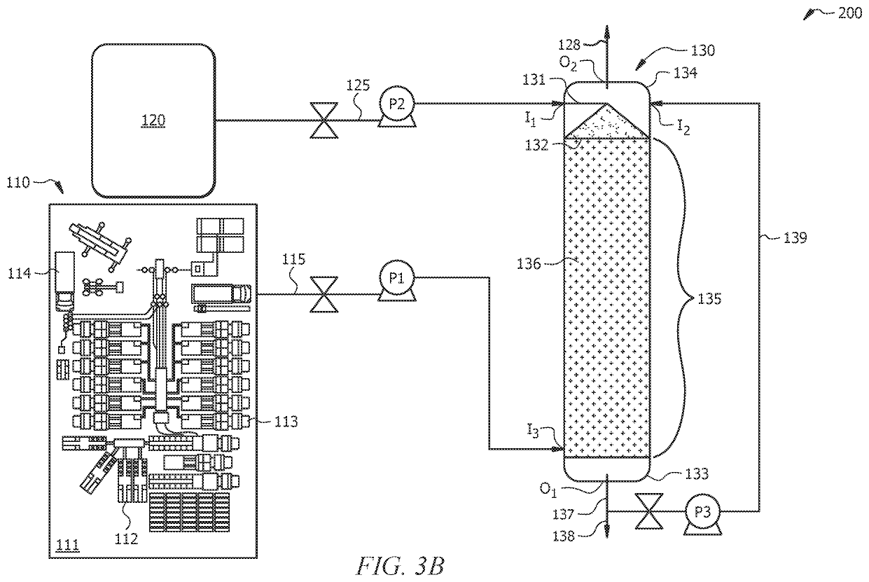

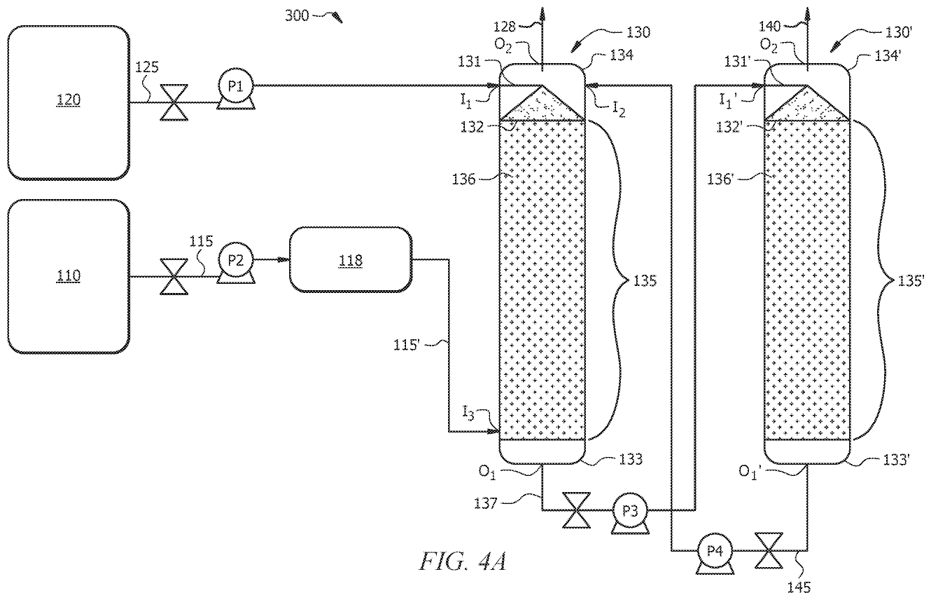

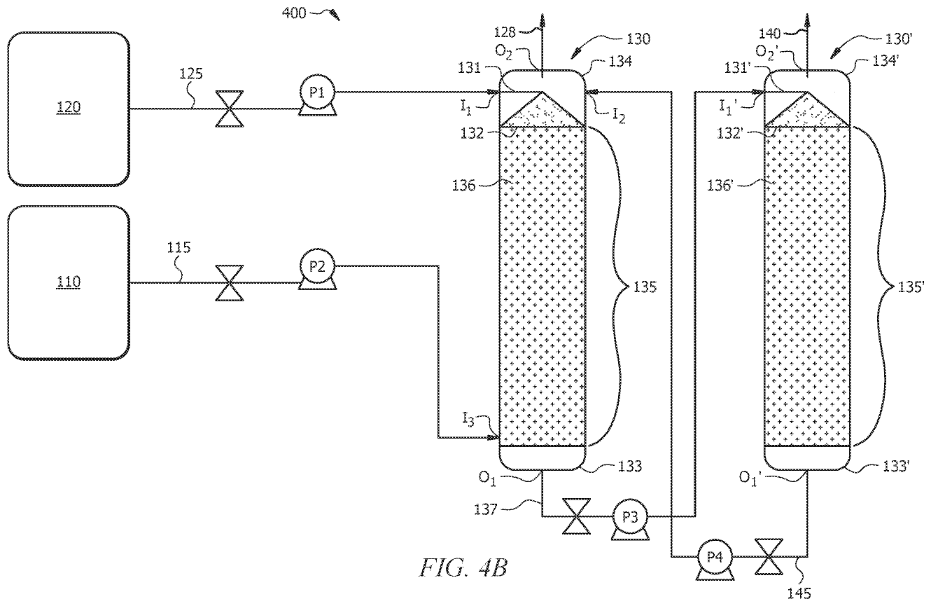

The method of this disclosure will now be further detailed and a system for carrying out the method according to embodiments of this disclosure described with reference to FIG. 3A, which is a schematic of a system 100 according to one or more embodiments of this disclosure, FIG. 3B, which is a schematic of a system, 200 according to one or more embodiments of this disclosure, FIG. 4A, which is a schematic of a system, 300 according to one or more embodiments of this disclosure, and FIG. 4, which is a schematic of a system, 400 according to one or more embodiments of this disclosure.

With reference now to FIG. 3A, system 100 comprises: an exhaust gas collection system 110 configured for collecting exhaust gas 115 comprising carbon dioxide (CO₂) at a wellsite 111 to provide a collected exhaust gas (e.g., step 10 of FIG. 1) a heat exchanger 118 configured for removing heat from (i.e., cooling) the collected exhaust gas 115 to provide a cooled collected exhaust gas 115′ (e.g., step 20 of FIG. 1); and a packed bed chamber 130 configured for contacting the collected exhaust gas with water in the presence of a carbonic anhydrase catalyst 136 to hydrate the CO₂ and form a bicarbonate solution 137 (e.g., step 30 of FIG. 1). As noted in FIG. 3B, in embodiments in which a heat stable carbonic anhydrase catalyst 136 is employed, heat exchanger 118 may not be included in a system of this disclosure. As depicted in FIG. 3A, system 100 can further comprise a water source 120 for the water stream 125, and one or more pumps (e.g., pump P1 for pumping collected exhaust gas 115 to heat exchanger 118 and/or packed bed chamber 130, pump P2 configured for pumping water stream 125 from water source 120 to packed bed chamber 130, and/or pump P3 configured (e.g., in the embodiments of FIG. 3A and FIG. 3B) for pumping a portion 139 of bicarbonate solution 137 back to a top 134 of the packed bed chamber 130 or configured (e.g., in the embodiments of FIG. 4A and FIG. 4B) for pumping bicarbonate solution 137 or a portion 139 of bicarbonate solution 137 to a top 134′ of another packed bed chamber 130′).

As depicted in FIG. 4A and FIG. 4B, in embodiments, a system of this disclosure, such as system 300 of FIG. 4A and FIG. 400 of FIG. 4B, can include another packed bed chamber 130′ configured for extracting substantially pure CO₂ 140 from at least a portion of the bicarbonate solution 137 introduced thereto via pump P3. In such embodiments, a pump P4 can be configured to pump recycle water 145 to the top 134 of packed bed chamber 130. Additional details of the components of the system of this disclosure are provided hereinbelow.

As noted above with reference to FIG. 1, method I includes collecting exhaust gas comprising carbon dioxide (CO₂) at a wellsite to provide a collected exhaust gas 115 at 10. Collecting exhaust gas at 10 can be effected via exhaust gas collection apparatus 110. By way of example, as depicted in FIG. 3B, exhaust gas collection apparatus 110 can include and/or obtain the collected exhaust gas 115 from field operating equipment 112 at a wellsite 111. The field operating equipment 112 can comprise one or more vehicles (e.g., diesel trucks 114, cars, etc.), pumps (e.g., hydraulic pumps, fracturing pumps, etc.), or other equipment at a wellsite 111 that produces an exhaust gas comprising CO₂ from which collected exhaust gas 115 is obtained. Exhaust gas collection apparatus 110 can further comprise piping configured to combine the exhaust gas from a plurality of the field operating equipment 112 and introduce it to heat exchanger 118 and/or packed bed chamber 130, and/or storage apparatus to store the collected exhaust gas 115 prior to introduction into heat exchanger 118 and/or packed bed chamber 130. Collecting the collected exhaust gas 115 comprising CO₂ at 10 can be performed by piping exhaust gas from one or more pieces of field operating equipment or machinery 112 at a wellsite 111 to provide the collected exhaust gas 115.

The exhaust gas comprising CO₂ collected at step 10 can include greater than or equal to about 0.04, 0.1, 0.5, 1, 2, 3, 4, 5, 6, 7, 8, 9, 10, 20, 30, 40, 50, 60, 70, 80, 90, 95, or 100 volume percent (vol. %) CO₂. By way of examples, the collected exhaust gas comprising CO₂ 115 can include a waste gas, or one or more components thereof, produced at the wellsite 111 or another jobsite, such as, without limitation, one or more wellsites 111 or industrial plants. The one or more industrial plants can include, without limitation, a cement plant, a chemical processing plant, a mechanical processing plant, a refinery, a steel plant, a power plant (e.g., a gas power plant, a coal power plant, etc.), or a combination and/or a plurality thereof. In embodiments, the exhaust gas comprising CO₂ 115 comprises a waste gas that is a product of fuel combustion, for example, the product of an internal combustion engine, or a gas fired turbine engine, such as, for example, from a microgrid having electric pumps. In embodiments, the internal combustion engine includes an engine fueled by diesel, natural gas (e.g., methane), gasoline, or a combination thereof (e.g., a diesel engine 113, or a hybrid engine that is fueled by diesel and natural gas). The collected exhaust gas comprising CO₂ 115 can be produced at the wellsite 111 and/or another jobsite. A plurality of machinery 112 can be located and operated at a wellsite 111 for performing a subterranean formation operation, according to one or more embodiments of the present disclosure, and the collected exhaust gas comprising CO₂ 115 can, in embodiments, be obtained therefrom. For example, the exhaust gas comprising CO₂ from which the collected exhaust gas 115 can be produced at the wellsite 111 from machinery 112 used to perform a wellbore servicing operation. The machinery may include one or more internal combustion or other suitable engines that consume fuel to perform work at the wellsite 111 and produce exhaust gas comprising CO₂ from which collected exhaust gas 115 is collected.

The wellbore 101 at wellsite 111 may be a hydrocarbon-producing wellbore (e.g., oil, natural gas, and the like) or another type of wellbore for producing other resources (e.g., mineral exploration, mining, and the like). Machinery 112 typically associated with a subterranean formation operation related to a hydrocarbon producing wellbore, and from which the exhaust gas comprising CO₂ can be produced, can be utilized to perform such operations as, for example, a cementing operation, a fracturing operation, or other suitable operation where equipment is used to drill, complete, produce, enhance production, and/or work over the wellbore. Other surface operations may include, for example, operating or construction of a facility.

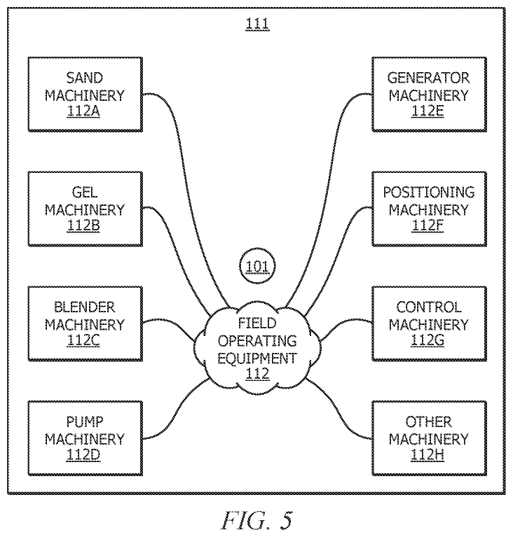

As depicted in FIG. 5, which is a schematic of a plurality of machinery or field operating equipment 112 that may be located and operated a wellsite 111 for performing a subterranean formation operation and may produce exhaust gas comprising CO₂ from which collected exhaust gas 115 is collected, according to one or more embodiments of the present disclosure, the machinery 112 from which the exhaust gas comprising CO₂ can be produced, in embodiments, can include sand machinery 112A, gel machinery 112B, blender machinery 112C, pump machinery 112D, generator machinery 112E, positioning machinery 112F, control machinery 112G, and other machinery 112H. The machinery 112 may be, for example, truck, skid or rig-mounted, or otherwise present at the wellsite 111, without departing from the scope of the present disclosure. The sand machinery 112A may include transport trucks or other vehicles for hauling to and storing at the wellsite 111 sand for use in an operation. The gel machinery 112B may include transport trucks or other vehicles for hauling to and storing at the wellsite 111 materials used to make a gelled treatment fluid for use in an operation. The blender machinery 112C may include blenders, or mixers, for blending materials at the wellsite 111 for an operation. The pump machinery 112D may include pump trucks or other vehicles or conveyance equipment for pumping materials down the wellbore 101 for an operation. The generator machinery 112E may include generator trucks or other vehicles or equipment for generating electric power at the wellsite 111 for an operation. The electric power may be used by sensors, control machinery, and other machinery. The positioning equipment 112F may include earth movers, cranes, rigs or other equipment to move, locate or position equipment or materials at the wellsite 111 or in the wellbore 101.

The control machinery 112G may include an instrument truck coupled to some, all, or substantially all of the other equipment at the wellsite 111 and/or to remote systems or equipment. The control machinery 112G may be connected by wireline or wirelessly to other equipment to receive data for or during an operation. The data may be received in real-time or otherwise. In another embodiment, data from or for equipment may be keyed into the control machinery.

The control machinery 112G may include a computer system for planning, monitoring, performing or analyzing the job. Such a computer system may be part of a distributed computing system with data sensed, collected, stored, processed and used from, at or by different equipment or locations. The other machinery 112H may include equipment also used at the wellsite 111 to perform an operation.

In other examples, the other machinery 112H may include personal or other vehicles used to transport workers to the wellsite 111 but not directly used at the wellsite 111 for performing an operation.

Many if not most of these various machinery 112 at the wellsite 111 accordingly utilize a diesel or other fuel types to perform their functionality. Such fuel is expended and exhausted as exhaust gas, such as exhaust gas including CO₂. The embodiments described herein provide a system and method for collecting, converting to urea, and, thus, sequestering CO₂ from such machinery 112 located and operated at a wellsite 111, thus reducing atmospheric CO₂ emissions, while reducing material and time costs. It is to be appreciated that other configurations of the wellsite 111, including other machinery 112 at the wellsite 111 or another jobsite, may be employed, without departing from the scope of the present disclosure. Although a number of various machinery 112 at a jobsite (e.g., a wellsite 111) have been mentioned, many other machinery may utilize diesel or other fuel that creates exhaust gas including CO₂ that may conventionally be exhausted into the atmosphere, but herein utilized to form urea as described herein.

In some embodiments, the present disclosure provides capturing exhaust gas comprising CO₂ 115 from such machinery located and operated at a wellsite 111 and utilizing such exhaust gas to form urea as detailed herein.

Although described hereinabove with reference to a wellsite 111, the source of the collected exhaust gas comprising CO₂ 115 that is collected at step 10 of the method I can be any convenient CO₂ source. The CO₂ source can be a gaseous CO₂ source. This gaseous CO₂ may vary widely, ranging from air, industrial waste streams, etc. As noted above, the gaseous CO₂ can, in certain instances, comprise an exhaust waste product from an industrial plant. The nature of the industrial plant may vary in these embodiments, where industrial plants of interest include power plants, chemical processing plants, and other industrial plants that produce exhaust gas comprising CO₂ as a byproduct. By waste stream is meant a stream of gas (or analogous stream) that is produced as a byproduct of an active process of the industrial plant, e.g., an exhaust gas. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Particular multi-component gaseous streams of interest that may be treated according to the subject invention include: oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

As noted above, in embodiments, the collected exhaust gas comprising CO₂ 115 comprises greater than or equal to about 5, 6, 7, 8, 9, 10, 15, 20, 25, 30, 40, 50, 60, 70, 80, 90, 95, 96, 97, 98, 99, or 100 volume percent (vol %) CO₂. In embodiments, the exhaust gas comprising CO₂ 115 comprises primarily CO₂ (e.g., greater than or equal to about 50, 60, 70, 80, 90, 95, 96, 97, 98, 99, or 100 volume percent (vol %) CO₂). For example, when the collected exhaust gas comprising CO₂ 115 is obtained from a waste gas produced at a different jobsite (e.g., at an another jobsite) than the wellsite 111, CO₂ can be separated from the waste gas in order to reduce a volume of gas to be transported to the wellsite 111. For example, when the exhaust gas includes a flue gas from a power plant, which typically contains from about 7 to about 10 vol. % CO₂, the method I can further include transporting the exhaust gas comprising CO₂ (or a waste gas from which the collected exhaust gas comprising CO₂ 115 is obtained) from the another jobsite at which the waste gas is obtained to the wellsite 111. In embodiments, the method I can further include separating the exhaust gas from the waste gas comprising CO₂, to reduce a volume of gas, e.g., for transport. Although the separating of the exhaust gas comprising CO₂ from the waste gas can be performed at the wellsite 111 (e.g., after transport of the waste gas from the another jobsite at which the waste gas is obtained and/or produced to the wellsite 111), to facilitate transportation, the separating of the collected exhaust gas comprising CO₂ 115 from the waste gas can be performed at the another jobsite at which the waste gas is produced and/or obtained and, subsequently, the collected exhaust gas comprising CO₂ 115 can be transported to the wellsite 111.

In embodiments, contacting the collected exhaust gas 115 with water in the presence of the carbonic anhydrase catalyst 136 to form the bicarbonate solution 137 at 30 comprises introducing the collected exhaust gas 115 into a packed bed chamber 130 comprising a packed bed 135 comprising the carbonic anhydrase catalyst 136. Contacting the collected exhaust gas 115 with water in the presence of the carbonic anhydrase catalyst 136 to form the bicarbonate solution 137 can further comprise introducing a stream comprising the water (e.g., water stream 125 and/or recycled bicarbonate solution 139) via a top 134 of the packed bed chamber 130 and injecting the collected exhaust gas 115 via a bottom 133 of the packed bed chamber 130.

The packed bed chamber 130 can comprise a packed bed 135 of carbonic anhydrase catalyst 136 and is configured for contacting, at 30, the collected exhaust gas 115 (or, in the embodiments of FIG. 3A and FIG. 4A) the cooled collected exhaust gas 115′) with water (e.g., water stream 125 and/or recycle bicarbonate solution 139) in the presence of the carbonic anhydrase catalyst 136 to hydrate the CO₂ and form bicarbonate solution 137. The packed bed chamber 130 can further comprise an inlet for the water (e.g., inlet I1 for water stream 125 and/or inlet I2 for recycled bicarbonate solution 139, or a single inlet for a combined stream thereof) at or near top 134 of the packed bed chamber 130 and an inlet I3 for the collected exhaust gas 115 at or near bottom 133 of the packed bed chamber 130. The packed bed chamber 130 can further include an outlet O1 for bicarbonate solution 137 at or near bottom 133 of the packed bed chamber 130 and an outlet O2 for removing a CO₂-reduced gas 128 at or near top 134 of the packed bed chamber 130. A system of this disclosure can further include an injection apparatus 131 and/or spraying apparatus 132 for injecting and/or spraying, respectively, the water (e.g., water stream 125 and/or recycled bicarbonate solution 139) from at or near the top 134 of the packed bed chamber 130 over the packed bed 135. A recycle bicarbonate solution line 139 can be utilized for recycling at least a portion of the bicarbonate solution 137 to the top 134 of the packed bed chamber 130 as at least a portion of the water introduced into packed bed chamber 130 during the contacting at 30 of FIG. 1.

Method I can further comprise removing the bicarbonate solution 137 from the bottom 133 of the packed bed chamber 130 and removing a CO₂-reduced gas 128 from a top 134 of the packed bed chamber 130. Introducing the stream comprising the water 125 via the top 134 of the packed bed chamber 130 can further comprise injecting and/or spraying the water 125 from the top 134 of the packed bed chamber 130 over the packed bed 135. The stream of water can include a water stream 125 from a water source 120 and/or a recycle stream 139 comprising at least a portion of the bicarbonate solution 137. The bicarbonate solution 137 can comprise from about 5 to about 100 weight percent (wt %), from about 5 to about 75 wt %, or from about 5 to about 50 wt %, or greater than or equal to about 5, 10, or 25 wt % bicarbonate. Via recycling of at least a portion of the bicarbonate solution 137 via recycle bicarbonate solution 139, the bicarbonate solution extracted via unrecycled bicarbonate solution 138 can be a bicarbonate-laden solution comprising greater than or equal to about 50, 60, 70, 80, 90, 91, 92, 93, 94, 95, 96, 97, 98, 99, or 100 wt % bicarbonate. Recycle of bicarbonate via recycle bicarbonate solution 139 can thus serve to increase a concentration of bicarbonate in the bicarbonate solution 137/138, and can reduce an amount of water (e.g., water stream 125) utilized by the system and method.

In embodiments, the packed bed 135 can comprise particulates coated with the carbonic anhydrase catalyst 136. At least a portion of the particulates can be organic, at least a portion of the particulates can be inorganic, or a first portion of the particulates can be organic and a second portion of the particulates can be inorganic. By way of nonlimiting examples, in embodiments, the particulates comprise sand, alumina, porous silica, porous polymer beads, porous ceramic particulates, or a combination thereof. Desirably, the particulates provide a large surface area for carbonic anhydrase catalyst. For example, in embodiment, the particulates have a surface area, e.g., a BET surface area, in a range of from about 0.1 to about 100, from about 0.1 to about 25, from about 0.1 to about 10, or greater than or equal to about 1, 2, 3, 4, or 5 m²/g. The carbonic anhydrase catalyst 136 (136′, FIGS. 4A/4B) can be a natural (e.g., from bacteria) or synthetic (e.g., manmade) metalloenzyme. For example, in embodiments, the carbonic anhydrase catalyst 136 can comprise carbonic anhydrase derived from or producible by bacteria of the genus Caminibacter. The carbonic anhydrase catalyst 136 can comprise a zinc containing metalloenzyme selected from 60 -carbonic anhydrase, β-carbonic anhydrase, and γ-carbonic anhydrase.

In embodiments, the carbonic anhydrase catalyst can be entrapped in a polymeric immobilization material to stabilize the carbonic anhydrase catalyst 136 (e.g., metalloenzyme) and anchor it in place on the particulates within the packed bed 135. The polymeric immobilization material can be selected from polysulfone, polycarbonate, poly(vinylbenzyl chloride), polysiloxanes, or a combination thereof. In embodiments, the carbonic anhydrase catalyst 136 can be immobilized in the packed bed 135/135′ by covalent grafting on silica coated porous steel, wherein the silica coated porous steel provides a support packed matrix in the packed bed chamber 130. In such embodiments, the collected exhaust gas 115 can be injected into the bottom 133 of packed bed chamber 130 to allow the gas permeating upward through the carbonic anhydrase catalyst-coated porous steel packed matrix 136, while an aqueous liquid (e.g., water stream 125 and/or recycle bicarbonate solution 139) can be being injected and sprayed down from the top 134 of the packed matrix 136 to provide a counterflow with the permeating collected exhaust gas 115, allowing the CO₂ in the collected exhaust gas 115 to dissolve into the aqueous liquid and catalyzing the hydration of the dissolved CO₂ to produce a solution 137 of bicarbonate ions.

As noted hereinabove, the method of this disclosure can further comprise, at 20, cooling the collected exhaust gas 115 prior to contacting the collected exhaust gas 115 with water (e.g., in water stream 125 and/or recycle line 139) in the presence of a carbonic anhydrase catalyst 136 to form bicarbonate solution 137. A system of this disclosure can thus further comprise a heat exchanger 118 upstream of the packed bed chamber 130 and configured for cooling the collected exhaust gas 115 prior to introduction into the packed bed chamber 130, as depicted in system 100 of FIG. 3A and system 300 of FIG. 4A. Cooling can comprise cooling (e.g., from a collected exhaust gas 115 temperature of greater than or equal to about 300, 400, 500, 600, 700° F., or more (149, 204, 260, 316, 371° C.) to a temperature of less than or equal to about 120° F., 110° F., 100° F., or 90° F. (48.9° C., 43.3° C., 37.8° C., or 32.2° C.). The heat extracted via heat exchanger 118 can be utilized elsewhere, for example and without limitation, steam produced via heat exchanger 118 can be utilized for process heating, drying, or concentrating, steam cracking, distillation, or any of a number of different purposes. By maintaining a temperature of the packed bed chamber 130 (and any downstream packed bed chamber 130′, discussed hereinbelow) at a temperature at which the carbonic anhydrase catalyst 136 does not denature, the carbonic anhydrase catalyst (e.g., metalloenzyme) can catalyze the hydration of CO₂ for conversion to bicarbonate, and, acting as a catalyst, not be consumed in the reaction.

The method I of this disclosure can comprise substantially continuously collecting, at 10, the exhaust gas comprising carbon dioxide (CO₂) at the wellsite 111 to provide the collected exhaust gas 115; and/or substantially continuously contacting, at 30, the collected exhaust gas 115 with water 125/139 in the presence of the carbonic anhydrase catalyst 136 to form the bicarbonate solution 137.

As depicted in FIG. 1, method I can comprise, at 40, further processing the bicarbonate solution 137 (e.g., at least a portion 138 of the bicarbonate solution 137 that is not recycled to top 134 of packed bed chamber 130) to produce a product. In such embodiments, system of this disclosure can further include any suitable apparatus known to those of skill in the art and with the help of this disclosure for producing a product from the bicarbonate solution 137/138.

By way of nonlimiting example, the product produced from the bicarbonate solution 138 can comprise a carbonate and/or a bicarbonate. For example, in embodiments, the method I can further include contacting the bicarbonate solution 137/138 with one or more metal oxides, metal hydroxides, or metal silicates to produce the product. In such embodiments, the product can comprise calcium carbonate (CaCO₃), magnesium carbonate (MgCO₃), potassium carbonate (K₂CO₃), sodium carbonate (Na₂CO₃), potassium bicarbonate (KHCO₃), sodium bicarbonate (NaHCO₃), or a combination thereof.

Accordingly, in embodiments, the method of this disclosure can include mixing, to provide a mixed solution, the produced bicarbonate solution 137/138 with one or more metal oxides, metal hydroxides, or metal silicates, that provide a source of monovalent or divalent cations, to produce metal carbonate (or bicarbonate) materials, such as CaCO₃, MgCO₃, KHCO₃, K₂CO₃, NaHCO₃, Na₂CO₃, that form solids and precipitate from the mixed solution. The pH of the mixed solution can be maintained above about 9 to 10 (e.g., by adding a hydroxide (OH⁻) source or “proton removing agent”, whereby carbonate anion can be formed as shown in reaction 4:

HCO₃⁻(aq)+OH⁻↔CO₃²⁻(aq)+H₂O [4]

The metal cations can react with carbonate anion to form metal carbonate solids or precipitate according to reaction 5:

mX(aq)°nCO₃²⁻↔Xₘ(CO₃)ₙ(s) [5]

wherein X is a metal cation (or a combination of metal cations) that can chemically bond with a carbonate group; and m and n are stoichiometric positive integers. For example, suitable metal cations include Ca²⁺ or Mg²⁺, in which cases CaCO₃ or MgCO₃ can be formed as shown in reactions 6 and 7, respectively:

Ca²⁺+CO₃²⁻→CaCO₃ [6]

Mg²⁺+CO₃²⁻→MgCO₃ [7]

In embodiments, as depicted in FIG. 1, method I further comprises, at 50, injecting at least a portion of the bicarbonate solution 137/138 into a well 101 (FIG. 5) at the or another wellsite 111 to sequester (e.g., temporarily (e.g., less than 0.25, 0.5, 1, 2, 3, 4, 5, 10, 20, 50, or 100 years) or permanently (e.g., greater than or equal to 100, 200, 300 years, or more, absent intervention) sequester) CO₂ in a subterranean formation surrounding the wellbore. In such embodiments, a system of this disclosure can further include apparatus for injecting at least a portion of the bicarbonate solution 137/138 into a well 101 at the or another wellsite 111 to sequester (e.g., temporarily or substantially permanently sequester) CO₂ in a subterranean formation. Once injected downhole, the bicarbonate solution 137/138 can contact divalent cations to produce a cement-like material, or carbonate, such as calcium carbonate and magnesium carbonate, as noted hereinabove with reference to further processing at 40 of FIG. 1.

In embodiments, as depicted in FIG. 1, method I further comprises, at 60, producing substantially pure CO₂ from the bicarbonate solution 137/138. The substantially pure CO₂ can comprise greater than or equal to about 95, 96, 97, 98, 99, 99.1, 99.2, 99.3, 99.4, 99.5, 99.6, 99.7, 99.8, 99.9, or 100 volume percent (vol %) CO₂. As depicted in FIG. 2, which is a schematic flow diagram of separating CO₂ from bicarbonate solution, 60, according to embodiments of this disclosure, producing substantially pure CO₂ from the bicarbonate solution at 60 can include, at 61, introducing the bicarbonate solution 137 or a portion 138 thereof that is not recycled to top 134 of packed bed chamber 130 into another (e.g., a second) packed bed chamber 130′ comprising the or another carbonic anhydrase catalyst 136′ to form the substantially pure CO₂ 140. Introducing the bicarbonate solution 137/138 into the packed bed chamber 130′ comprising the or the another carbonic anhydrase catalyst 136′ to form the substantially pure CO₂ 140 can further comprises introducing the bicarbonate solution 137/138 to a top 134′ of the another packed bed chamber 130′ and removing the substantially pure CO₂ 140 from the top 134′ of the packed bed chamber 130′ and a separated water stream 145 comprising water from a bottom 133′ of the packed bed chamber 130′.

In embodiments, contacting the collected exhaust gas 115 with water (e.g., in water stream 125 or recycle bicarbonate solution 139) in the presence of the carbonic anhydrase catalyst 136 to hydrate the CO₂ and form the bicarbonate solution 137 comprises contacting the collected exhaust gas 115 with at least a portion of the separated water stream 145. That is, separated water stream 145 can be recycled to the (e.g., first) packed bed chamber 130 as the water (e.g., alone or in combination with the water in water stream 125 and/or recycled bicarbonate solution 139).

Accordingly, as depicted in FIG. 4A and FIG. 4B, a system 300/400 of this disclosure can further include another (e.g., a second) packed bed chamber 130′ comprising another packed bed 135′. The packed bed chamber 130′ is configured for producing substantially pure CO₂ 140 from the bicarbonate solution 137/138 introduced thereto. The packed bed 135′ can comprise a carbonic anhydrase catalyst 136′ that can be the same carbonic anhydrase catalyst as carbonic anhydrase 136 of packed bed chamber 130, or can comprise another carbonic anhydrase catalyst.

The packed bed chamber 130′ can be substantially the same as packed bed chamber 130, described hereinabove, in embodiments. In embodiments, packed bed chamber 130′ comprises particulates coated with the or the another carbonic anhydrase catalyst 136′. At least a portion of the particulates can be organic, at least a portion of the particulates can be inorganic, or a first portion of the particulates can be organic and a second portion of the particulates can be inorganic. As with carbonic anhydrase catalyst 136 of packed bed chamber 130, carbonic anhydrase catalyst 136′ can be entrapped in a polymeric immobilization material and/or immobilized by covalent grafting on silica coated porous steel to stabilize the enzyme and anchor it in place on the particulates and in the packed bed 135′.

The another packed bed chamber 130′ can comprise an inlet I1′ at or near a top 134′ thereof and configured for introducing the bicarbonate solution 137, an outlet O2′ at or near the top 134′ thereof and configured for removal of the substantially pure CO₂ 140 from the top 134′ of the another packed bed chamber 130′, and an outlet O1′ at or near the bottom 133′ thereof for a separated or recycle water stream 145 comprising water. The another (e.g., second) packed bed chamber 130′ can be fluidly attached with the (e.g., first) packed bed chamber 130 via a recycle line configured for introducing at least a portion of the separated water 145 from the another packed bed chamber 130′ to the packed bed chamber 130 as at least a portion of the water stream (e.g., alone via inlet I2 or in combination with water stream 125 via inlet I1). The another packed bed chamber 130′ can be operated under acidic conditions, whereby the reaction of Equation [3] above occurs to protonate the bicarbonate and produce the substantially pure CO₂ 140 from the bicarbonate solution 137/138 introduced into the downstream packed bed chamber 136′. In alternative embodiments, the packed bed chamber 130′ is operated at a temperature of about 10° C. to 50° C. higher than that of the packed bed chamber 130. In alternative embodiments, a physical membrane or other system can be utilized to capture the CO₂ in bicarbonate stream 137/138.

As depicted in the flow diagram of FIG. 2, in embodiments, producing CO₂ from the bicarbonate solution 137/138 can further comprising compressing the substantially pure CO₂ 140, at 62, and/or utilizing at least a portion of the substantially pure CO₂ 140 and/or the compressed substantially pure CO₂ in an industrial process at 63. Accordingly, a system of this disclosure can further include apparatus for compressing the substantially pure CO₂ and/or utilizing at least a portion of the substantially pure CO₂ or the compressed substantially pure CO₂ in another process. For example, the method can include injecting at least a portion of the substantially pure CO₂ 140 in an enhanced oil recovery (EOR) operation, in embodiments. In such embodiments, the system can further include enhanced oil recovery (EOR) apparatus configured for injecting at least a portion of the substantially pure CO₂ 140 downhole (e.g., via the or another wellbore 101).

Also disclosed herein is a method comprising: producing bicarbonate solution 137/138 comprising bicarbonate via hydration, in the presence of a carbonic anhydrase catalyst 136, of carbon dioxide in an exhaust gas 115 produced at a wellsite 111. The producing can be performed substantially continuously, in embodiments. As described above, the bicarbonate solution 137/138 can comprise from about 5 to about 100 weight percent (wt %), from about 5 to about 75 wt %, or from about 5 to about 50 wt %, or greater than or equal to about 5, 10, or 25 wt % bicarbonate.

In embodiments, a method of continuously capturing CO₂ from the exhaust gas of fracturing equipment comprises: providing a source of exhaust gas 115 collected from fracturing equipment during an operation at wellsite 111 (and/or by trucking in (or pipeline) the captured CO₂ from another wellsite 111 or from another source, such as from a power plant, cement plant, etc.); providing one or more packed bed chambers 130, wherein each packed bed chamber 130 comprises immobilized solid particulate catalyst 136 that comprises particulates that have been coated with a carbonic anhydrase to catalyze hydration of CO₂ and enhance the separation of CO₂ from the collected exhaust gas 115; injecting the collected exhaust gas 115 into the one or more packed bed chambers 130 to allow the gas permeating through a carbonic anhydrase catalyst 136-coated packed bed 135 from the bottom 133 of the packed bed chamber 130, while water (e.g., in water stream 125 and/or recycle bicarbonate solution 139) is being injected and sprayed down from the top 134 of the packed bed chamber 130 to provide a counterflow with the permeating gas (FIG. 3A-4B); allowing the carbonic anhydrase catalyst 136 to speed up the reaction (Equation [1]) of CO₂ in the collected exhaust gas 115 with water to form carbonic acid and its conversion into bicarbonate ions; allowing CO₂-depleted gas 128 to exit from the top 134 of the one or more packed bed chambers 130, and the bicarbonate-laden solution 137 to exit from the bottom 133 of the one or more chambers 130; allowing a portion 139 of the produced bicarbonate-laden solution 137 to cycle back to the top 134 of the one or more packed bed chambers 130.

The system and method of this disclosure can provide for continuous, semi-continuous, or intermittent collecting of exhaust gas 115 from field operating equipment 112 at a wellsite 111 and production of bicarbonate solution 137/138 therefrom as detailed herein. In embodiments, the capture of CO₂ in the collected exhaust gas 115 and/or the conversion to bicarbonate solution 137/138 are substantially continuous. The system and method allow for continuous “on-the-fly” capture of CO₂ from collected exhaust gas 115, in embodiments. The bicarbonate solution 137/138 can be utilized to form another product at the wellsite 111, for example, as magnesium carbonate, calcium carbonate, etc., the bicarbonate solution 137/138 can be introduced downhole, whereby reaction with divalent cations sequesters the CO₂ downhole, and/or substantially pure CO₂ can be separated from the bicarbonate solution 137/138 as described herein and the pure CO₂ utilized elsewhere (e.g., introduced downhole during enhanced oil recovery (EOR) and/or for sequestration downhole).

Via the system and method of this disclosure, CO₂ can be continuously captured and separated from the exhaust gas produced from the equipment being operated at wellsite 111. The method of capturing CO₂ can comprises continuously injecting the exhaust gas 115 collected from the equipment (e.g., field operating equipment 112) operating at wellsite 111 into one or more packed bed chambers 130, wherein each packed bed chamber 130 contains particulates that have been treated and coated with a carbonic anhydrase catalyst 136 , or any other suitable catalyst, to enhance and expedite the separation of CO₂ from the exhaust gas 115 via removal from the one or more packed bed chambers 130 in the form of bicarbonate-laden solution 137. The bicarbonate solution 137 can be processed further, as detailed hereinabove (e.g., as described at 40 of FIG. 1), into other beneficial products, converted back to CO₂ 140 (e.g., for sales, EOR applications, or fracturing stimulation treatments (e.g., as described at 40 of FIG. 1)), or simply reinjecting into subterranean formation(s) for permanent sequestration (e.g., as described at 50 of FIG. 1).

Comparing to conventional batch reactor processes that can only handle a fixed volume, the system and method described herein provide for separating and capturing CO₂ from large or substantially unlimited and variable volumes of exhaust gas produced from a wellsite 111, another wellsite 111, and/or one or more industrial plants. Using the capability of carbonic anhydrase to catalyze the conversion of CO₂ to bicarbonate 137 as detailed herein at a very high rate overcomes the slow reaction rates and environmental issues in relation to other CO₂ capture processes. The disclosed system and method can also enable operation at low ambient temperature to moderately high temperatures (without requiring a heat exchanger 118, in some embodiments utilizing heat stable carbonic anhydrase catalyst(s)) and atmospheric pressure.

The system and method described herein allow for transforming the polluted exhaust gas (e.g., collected exhaust gas 115) into a much cleaner air (e.g., CO₂-reduced gas 128); enable capture of CO₂ from potentially massive amounts of exhaust gas produced at a wellsite(s) 111; enable direct converting of the CO₂ in the collected exhaust gas 115 into bicarbonate 137/138 to remove CO₂ from the collected exhaust gas 115 and potentially transform (e.g., at 40 of FIG. 1) it into useful products (e.g., metal carbonates, bicarbonates), inject separated CO₂ 140 (e.g., at 60 of FIG. 1) into subterranean formations as part of EOR operation or fracturing stimulation treatment, or for permanent sequestration; and/or inject the bicarbonate solution 137 downhole (e.g., at 50 of FIG. 1) for sequestration. The disclosed system and method thus provide economical strategy for capturing CO₂ with long lasting carbonic anhydrase 136 to maintain efficiency of CO₂ conversion without frequent regeneration of the carbonic anhydrase catalyst 136. The disclosed system and method can provide a viable continuous process using small processing equipment at a wellsite 111, while reducing capital and operating costs.

As shown in FIG. 3A and FIG. 4A, the system and method of capturing CO₂ in the exhaust gas produced from the equipment (e.g., at a wellsite(s) 111) can utilize a low-temperature carbonic anhydrase (i.e., a carbonic anhydrase that denatures at high temperature) to produce bicarbonate as a precursor to making beneficial products, producing CO₂, or sequestering in subterranean formation. In such embodiments, a heat exchanger 118 can be utilized to cool the collected exhaust gas 115 to a temperature at which the carbonic anhydrase catalyst 136 remains stable (e.g., does not denature) prior to contact of the collected exhaust gas 115 with the carbonic anhydrase catalyst 136/136′. As shown in FIG. 3B and FIG. 4B, in embodiments, the system and method of this disclosure can utilize a high-temperature carbonic anhydrase (i.e., a carbonic anhydrase that remains stable at higher temperatures) to produce bicarbonate as a precursor to making beneficial products, producing CO₂, or sequestering in subterranean formation. In such embodiments, heat exchanger 118 can be absent, and no cooling of the collected exhaust gas 115 utilized prior to contact of the collected exhaust gas 115 with the carbonic anhydrase catalyst 136/136′. As described hereinabove with regard to FIG. 3A and FIG. 3B, in embodiments, the bicarbonate solution 137/138 is further processed (e.g., as indicated at 40 of FIG. 1) to produce further products, and/or the bicarbonate solution 137/138 is injected downhole processed (e.g., as indicated at 50 of FIG. 1) for sequestration. Alternatively, as described hereinabove with reference to FIG. 4A and FIG. 4B, another packed bed chamber 130′ can be utilized to separate substantially pure CO₂ 140 from the bicarbonate solution 137/138 processed (e.g., as indicated at 60 of FIG. 1), which separated substantially pure CO₂ 140 can be injected downhole, e.g., utilized for EOR, hydraulic fracturing, well stimulation, or simply sequestration, or otherwise utilized and/or sequestered.

In embodiments, the system of this disclosure can be provided on a skid (e.g., a trailer skid), whereby CO₂ can be separated from at least a portion of the collected exhaust gas as described herein via production of bicarbonate solution 137/138, and optionally, the bicarbonate solution 137/138 can be utilized to produce another product (e.g., CaCO₃, MgCO₃, etc.), injected downhole for sequestration or another purpose, or substantially pure CO₂ can be removed from bicarbonate solution 137/138 for subsequent use (e.g., injection downhole during EOR, or another use).

In embodiments, at least a portion of the system 100/200/300/400 (e.g., packed bed chamber(s) 130 and/or packed bed chamber(s) 130′) can be provided as a small-scale CO₂ separation plant (e.g., on one or more skids) at a wellsite 111, whereby bicarbonate solution 137/138 can be produced on location, substantially pure CO₂ can be produced on location, and/or a further product produced at 40 can be produced on location.

### ADDITIONAL DISCLOSURE

The following are non-limiting, specific embodiments in accordance with the present disclosure:

In a first embodiment, a method comprises: collecting exhaust gas comprising carbon dioxide (CO₂) at a wellsite to provide a collected exhaust gas; and contacting the collected exhaust gas with water in the presence of a carbonic anhydrase catalyst to hydrate the CO₂ and form a bicarbonate solution.

A second embodiment can include the method of the first embodiment, wherein contacting the collected exhaust gas with water in the presence of the carbonic anhydrase catalyst to form the bicarbonate solution further comprises introducing the collected exhaust gas into a packed bed chamber comprising a packed bed comprising the carbonic anhydrase catalyst.

A third embodiment can include the method of the second embodiment, wherein contacting the collected exhaust gas with water in the presence of the carbonic anhydrase catalyst to form the bicarbonate solution further comprises introducing a stream comprising the water via a top of the packed bed chamber and injecting the collected exhaust gas via a bottom of the packed bed chamber.

A fourth embodiment can include the method of the third embodiment further comprising removing bicarbonate solution from the bottom of the packed bed chamber and removing a CO₂-reduced gas from a top of the packed bed chamber.

A fifth embodiment can include the method of any one of the third or the fourth embodiments, wherein introducing the stream comprising the water via the top of the packed bed chamber further comprises injecting and/or spraying the water from the top of the packed bed chamber over the packed bed.

A sixth embodiment can include the method of any one of the fourth or the fifth embodiments, wherein the stream of water includes a recycle stream comprising at least a portion of the bicarbonate solution.

A seventh embodiment can include the method of any one of the second to sixth embodiments, wherein the packed bed comprises particulates coated with the carbonic anhydrase catalyst.

An eighth embodiment can include the method of the seventh embodiment, wherein the carbonic anhydrase catalyst comprises carbonic anhydrase derived from or producible by bacteria of the genus Caminibacter.

A ninth embodiment can include the method of any one of the seventh to eighth embodiments, wherein at least a portion of the particulates are organic, at least a portion of the particulates are inorganic, or wherein a first portion of the particulates are organic and a second portion of the particulates are inorganic.

A tenth embodiment can include the method of any one of the seventh to ninth embodiments, wherein the carbonic anhydrase catalyst is entrapped in a polymeric immobilization material to stabilize the enzyme and anchor it in place on the particulates.

An eleventh embodiment can include the method of any one of the second to tenth embodiments, wherein the carbonic anhydrase catalyst is immobilized by covalent grafting on silica coated porous steel, wherein the silica coated porous steel provides a support packed matrix in the packed bed chamber.

A twelfth embodiment can include the method of any one of the first to eleventh embodiments further comprising cooling the collected exhaust gas prior to contacting the collected exhaust gas with water in the presence of a carbonic anhydrase catalyst to form a bicarbonate solution.

A thirteenth embodiment can include the method of the twelfth embodiment, wherein cooling comprises cooling to a temperature of less than or equal to about 120° F., 110° F., 100° F., or 90° F. (48.9° C., 43.3° C., 37.8° C., or 32.2° C.).

A fourteenth embodiment can include the method of any one of the first to fourteenth embodiments, wherein the carbonic anhydrase catalyst comprises a zinc containing metalloenzyme selected from α-carbonic anhydrase, β-carbonic anhydrase, and γ-carbonic anhydrase.

A fifteenth embodiment can include the method of any one of the first to fourteenth embodiments comprising substantially continuously collecting the exhaust gas comprising carbon dioxide (CO₂) at the wellsite to provide the collected exhaust gas; and/or substantially continuously contacting the collected exhaust gas with water in the presence of the carbonic anhydrase catalyst to form the bicarbonate solution.

A sixteenth embodiment can include the method of any one of the first to fifteenth embodiments further comprising further processing the bicarbonate solution to produce a product.

A seventeenth embodiment can include the method of the seventeenth embodiment, wherein the product comprises a carbonate and/or a bicarbonate.

An eighteenth embodiment can include the method of the seventeenth embodiment, wherein the method further comprises contacting the bicarbonate solution with one or more metal oxides, metal hydroxides, or metal silicates to produce the product.

A nineteenth embodiment can include the method of the eighteenth embodiment, wherein the product comprises calcium carbonate (CaCO₃), magnesium carbonate (MgCO₃), potassium carbonate (K₂CO₃), sodium carbonate (Na₂CO₃), potassium bicarbonate (KHCO₃), sodium bicarbonate (NaHCO₃), or a combination thereof.

A twentieth embodiment can include the method of any one of the first to nineteenth embodiments further comprising producing substantially pure CO₂ from the bicarbonate solution.

A twenty first embodiment can include the method of the twentieth embodiment, wherein the substantially pure CO₂ comprises greater than or equal to about 95, 96, 97, 98, 99, 99.1, 99.2, 99.3, 99.4, 99.5, 99.6, 99.7, 99.8, 99.9, or 100 volume percent (vol %) CO₂.

A twenty second embodiment can include the method of any one of the twentieth to twenty first embodiments, wherein producing substantially pure CO₂ from the bicarbonate solution further comprises introducing the bicarbonate solution into a packed bed chamber comprising the or another carbonic anhydrase catalyst to form the substantially pure CO₂.

A twenty third embodiment can include the method of the twenty second embodiment, wherein introducing the bicarbonate solution into the packed bed chamber comprising carbonic anhydrase catalyst to form the substantially pure CO₂ further comprises introducing the bicarbonate solution to a top of the packed bed chamber and removing the substantially pure CO₂ from the top of the packed bed chamber and a separated water stream comprising water from a bottom of the packed bed chamber.

A twenty fourth embodiment can include the method of the twenty third embodiment, wherein contacting the collected exhaust gas with water in the presence of the carbonic anhydrase catalyst to hydrate the CO₂ and form the bicarbonate solution comprises contacting the collected exhaust gas with at least a portion of the separated water stream.

A twenty fifth embodiment can include the method of any one of the twenty second to twenty fourth embodiments, wherein the packed bed chamber comprises particulates coated with the or the another carbonic anhydrase catalyst.

A twenty sixth embodiment can include the method of the twenty fifth embodiment, wherein at least a portion of the particulates are organic, at least a portion of the particulates are inorganic, or wherein a first portion of the particulates are organic and a second portion of the particulates are inorganic.

A twenty seventh embodiment can include the method of any one of the twenty fifth to twenty sixth embodiments, wherein the carbonic anhydrase catalyst is entrapped in a polymeric immobilization material to stabilize the enzyme and anchor it in place on the particulates.

A twenty eighth embodiment can include the method of any one of the twenty second to twenty seventh embodiments further comprising compressing the substantially pure CO₂ and/or utilizing at least a portion of the substantially pure CO₂ and/or the compressed substantially pure CO₂ in an industrial process.

A twenty ninth embodiment can include the method of any one of the twenty second to twenty eighth embodiments further comprising injecting at least a portion of the substantially pure CO₂ in an enhanced oil recovery (EOR) operation.

A thirtieth embodiment can include the method of any one of the first to twenty ninth embodiments further comprising injecting at least a portion of the bicarbonate solution into a well at the or another wellsite to sequester CO₂ in a subterranean formation.

A thirty first embodiment can include the method of any one of the first to thirtieth embodiments, wherein the bicarbonate solution comprises from about 5 to about 100 weight percent (wt %), from about 5 to about 75 wt %, or from about 5 to about 50 wt %, or greater than or equal to about 5, 10, or 25 wt % bicarbonate.

In a thirty second embodiment, a system comprises an exhaust gas collection system configured for collecting exhaust gas comprising carbon dioxide (CO₂) at a wellsite to provide a collected exhaust gas; and a packed bed chamber comprising a packed bed of carbonic anhydrase catalyst and configured for contacting the collected exhaust gas with a water stream in the presence of the carbonic anhydrase catalyst to hydrate the CO₂ and form a bicarbonate solution.

A thirty third embodiment can include the system of the thirty second embodiment, wherein the packed bed chamber further comprises an inlet for the water stream at or near a top of the packed bed chamber and an inlet for the collected exhaust gas at or near a bottom of the packed bed chamber.

A thirty fourth embodiment can include the system of the thirty third embodiment, wherein the packed bed chamber further comprises an outlet for the bicarbonate solution at or near the bottom of the packed bed chamber and an outlet for removing a CO₂-reduced gas at or near a top of the packed bed chamber.

A thirty fifth embodiment can include the system of any one of the thirty third to thirty fourth embodiments further comprising injection and/or spraying apparatus for injecting and/or spraying the water stream from at or near the top of the packed bed chamber over the packed bed.

A thirty sixth embodiment can include the system of any one of the thirty second to the thirty fifth embodiments further comprising a recycle line for recycling at least a portion of the bicarbonate solution to the top of the packed bed chamber as at least a portion of the water stream.

A thirty seventh embodiment can include the system of any one of the thirty second to thirty sixth embodiments, wherein the packed bed comprises particulates coated with the carbonic anhydrase catalyst.

A thirty eighth embodiment can include the system of the thirty seventh embodiment, wherein at least a portion of the particulates are organic, at least a portion of the particulates are inorganic, or wherein a first portion of the particulates are organic and a second portion of the particulates are inorganic.

A thirty ninth embodiment can include the system of any one of the thirty second to thirty eighth embodiments, wherein the carbonic anhydrase catalyst comprises carbonic anhydrase derived from or producible by bacteria of the genus Caminibacter.

A fortieth embodiment can include the system of any one of the thirty second to thirty ninth embodiments, wherein the carbonic anhydrase catalyst is entrapped in a polymeric immobilization material to stabilize the carbonic anhydrase catalyst e.g., the enzyme) and retain the carbonic anhydrase catalyst in the packed bed.

A forty first embodiment can include the system of any one of the thirty second to fortieth embodiments, wherein the carbonic anhydrase catalyst is immobilized by covalent grafting on silica coated porous steel, wherein the silica coated porous steel provides a support packed matrix in the packed bed chamber.

A forty second embodiment can include the system of any one of the thirty second to forty first embodiments further comprising a heat exchanger upstream of the packed bed chamber and configured for cooling the collected exhaust gas prior to introduction into the packed bed chamber.

A forty third embodiment can include the system of any one of the thirty second to forty second embodiments, wherein the carbonic anhydrase catalyst comprises a zinc containing metalloenzyme selected from selected from α-carbonic anhydrase, β-carbonic anhydrase, and β-carbonic anhydrase.

A forty fourth embodiment can include the system of any one of the thirty second to forty third embodiments further comprising apparatus for producing a product from the bicarbonate solution.

A forty fifth embodiment can include the system of the forty fourth embodiment, wherein the product comprises a carbonate and/or a bicarbonate.

A forty sixth embodiment can include the system of the forty fifth embodiment, wherein the product comprises calcium carbonate (CaCO₃), magnesium carbonate (MgCO₃), potassium carbonate (K₂CO₃), sodium carbonate (Na₂CO₃), potassium bicarbonate (KHCO₃), sodium bicarbonate (NaHCO₃), or a combination thereof.

A forty seventh embodiment can include the system of any one of the thirty second to forty sixth embodiments further comprising another packed bed chamber comprising another packed bed comprising the or another carbonic anhydrase catalyst, wherein the another packed bed chamber is configured for producing substantially pure CO₂ from the bicarbonate solution.

A forty eighth embodiment can include the system of the forty seventh embodiment, wherein the substantially pure CO₂ comprises greater than or equal to about 95, 96, 97, 98, 99, 99.1, 99.2, 99.3, 99.4, 99.5, 99.6, 99.7, 99.8, 99.9, or 100 volume percent (vol %) CO₂.

A forty ninth embodiment can include the system of the forty seventh or forty eighth embodiments, wherein the another packed bed chamber further comprises an inlet at or near a top thereof and configured for introducing the bicarbonate solution, an outlet at or near the top thereof and configured for removal of the substantially pure CO₂ from the top of the another packed bed chamber, and an outlet at or near the bottom thereof for a separated water stream comprising water.

A fiftieth embodiment can include the system of the forty ninth embodiment, wherein the another packed bed chamber is fluidly attached with the packed bed chamber via a recycle line configured for introducing at least a portion of the separated water stream from the another packed bed chamber to the packed bed chamber as at least a portion of the water stream.

A fifty first embodiment can include the system of any one of the forty seventh to fiftieth embodiments, wherein the another packed bed chamber comprises particulates coated with the or the another carbonic anhydrase catalyst.

A fifty second embodiment can include the system of the fifty first embodiment, wherein at least a portion of the particulates are organic, at least a portion of the particulates are inorganic, or wherein a first portion of the particulates are organic and a second portion of the particulates are inorganic.

A fifty third embodiment can include the system of the fifty second embodiment, wherein the carbonic anhydrase catalyst is entrapped in a polymeric immobilization material to stabilize the or the another carbonic anhydrase catalyst (e.g., metalloenzyme) and anchor it in place within the another packed bed.

A fifty fourth embodiment can include the system of any one of the forty seventh to fifty third embodiments further comprising apparatus for compressing the substantially pure CO₂ and/or utilizing at least a portion of the substantially pure CO₂ or the compressed substantially pure CO₂ in another process.

A fifty fifth embodiment can include the system of any one of the forty seventh to fifty fourth embodiments further comprising enhanced oil recovery (EOR) apparatus configured for injecting at least a portion of the substantially pure CO₂ downhole.

A fifty sixth embodiment can include the system of any one of the thirty second to fifty fifth embodiments further comprising apparatus for injecting at least a portion of the bicarbonate solution into a well at the or another wellsite to sequester CO₂ in a subterranean formation.

In a fifty seventh embodiment, a method comprises producing bicarbonate solution comprising bicarbonate via hydration, in the presence of a carbonic anhydrase catalyst, of carbon dioxide in an exhaust gas produced at a wellsite.

A fifty eighth embodiment can include the method of the fifty seventh embodiment, wherein the producing is performed substantially continuously.

A fifty ninth embodiment can include the method of any one of the fifty seventh or fifty eighth embodiments, wherein the bicarbonate solution comprises from about 5 to about 100 weight percent (wt %), from about 5 to about 75 wt %, or from about 5 to about 50 wt %, or greater than or equal to about 5, 10, or 25 wt % bicarbonate.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k* (Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
collecting exhaust gas comprising carbon dioxide (CO₂) at a wellsite to provide a collected exhaust gas; and
contacting the collected exhaust gas with water in the presence of a carbonic anhydrase catalyst to hydrate the CO₂ and form a bicarbonate solution.

2. The method of claim 1, wherein contacting the collected exhaust gas with water in the presence of the carbonic anhydrase catalyst to form the bicarbonate solution further comprises introducing the collected exhaust gas into a packed bed chamber comprising a packed bed comprising the carbonic anhydrase catalyst.

3. The method of claim 2, wherein contacting the collected exhaust gas with water in the presence of the carbonic anhydrase catalyst to form the bicarbonate solution further comprises introducing a stream comprising the water via a top of the packed bed chamber and injecting the collected exhaust gas via a bottom of the packed bed chamber.

4. The method of claim 3 further comprising removing the bicarbonate solution from the bottom of the packed bed chamber and removing a CO₂-reduced gas from a top of the packed bed chamber.

5. The method of claim 4, wherein the stream of water includes a recycle stream comprising at least a portion of the bicarbonate solution.

6. The method of claim 1 further comprising cooling the collected exhaust gas prior to contacting the collected exhaust gas with water in the presence of a carbonic anhydrase catalyst to form a bicarbonate solution.

7. The method of claim 1, wherein the carbonic anhydrase catalyst comprises a zinc containing metalloenzyme selected from selected from α-carbonic anhydrase, β-carbonic anhydrase, and 65 -carbonic anhydrase.

8. The method of claim 1 comprising substantially continuously collecting the exhaust gas comprising carbon dioxide (CO₂) at the wellsite to provide the collected exhaust gas; and/or substantially continuously contacting the collected exhaust gas with water in the presence of the carbonic anhydrase catalyst to form the bicarbonate solution.

9. The method of claim 1 further comprising further processing the bicarbonate solution to produce a product.

10. The method of claim 1 further comprising producing substantially pure CO₂ from the bicarbonate solution.

11. The method of claim 10, wherein producing substantially pure CO₂ from the bicarbonate solution further comprises introducing the bicarbonate solution into a packed bed chamber comprising the or another carbonic anhydrase catalyst to form the substantially pure CO₂.

12. The method of claim 1 further comprising injecting at least a portion of the bicarbonate solution into a well at the or another wellsite to sequester CO₂ in a subterranean formation.

13. A system comprising:
an exhaust gas collection system configured for collecting exhaust gas comprising carbon dioxide (CO₂) at a wellsite to provide a collected exhaust gas; and
a packed bed chamber comprising a packed bed of carbonic anhydrase catalyst and configured for contacting the collected exhaust gas with a water stream in the presence of the carbonic anhydrase catalyst to hydrate the CO₂ and form a bicarbonate solution.

14. The system of claim 13, wherein the packed bed chamber further comprises an inlet for the water stream at or near a top of the packed bed chamber, an inlet for the collected exhaust gas at or near a bottom of the packed bed chamber, an outlet for the bicarbonate solution at or near the bottom of the packed bed chamber, and an outlet for removing a CO₂-reduced gas at or near a top of the packed bed chamber.

15. The system of claim 14 further comprising a recycle line for recycling at least a portion of the bicarbonate solution to the top of the packed bed chamber as at least a portion of the water stream.

16. The system of claim 13 further comprising a heat exchanger upstream of the packed bed chamber and configured for cooling the collected exhaust gas prior to introduction into the packed bed chamber, and/or apparatus downstream of the packed bed chamber for producing a product from the bicarbonate solution.

17. The system of claim 13 further comprising another packed bed chamber comprising another packed bed comprising the or another carbonic anhydrase catalyst, wherein the another packed bed chamber is configured for producing substantially pure CO₂ from the bicarbonate solution, wherein the substantially pure CO₂ comprises greater than or equal to about 95 volume percent (vol %) CO₂.

18. A method comprising:
producing bicarbonate solution comprising bicarbonate via hydration, in the presence of a carbonic anhydrase catalyst, of carbon dioxide in an exhaust gas produced at a wellsite.

19. The method of claim 18, wherein the producing is performed substantially continuously.

20. The method of claim 18, wherein the bicarbonate solution comprises from about 5 to about 100 weight percent (wt %) bicarbonate.
